(19) United States
(12) Patent Application Publication
(10) Pub. No.: US 2014/0356784 A1
(43) Pub. Date: Dec. 4, 2014

(54) METHOD FOR CREATING A SCRATCH-OFF DOCUMENT WITH LOW ENERGY COMPONENTS

(71) Applicants: Dinesh Tyagi, Fairport, NY (US); Louise Granica, Victor, NY (US)

(72) Inventors: Dinesh Tyagi, Fairport, NY (US); Louise Granica, Victor, NY (US)

(21) Appl. No.: 13/906,384

(22) Filed: May 31, 2013

(51) Int. Cl. G03G 15/20

(52) U.S. Cl. CPC G03G 15/2003
USPC 430/124.13

(57) ABSTRACT

A method of creating a scratch-off document, the method includes the steps of providing a substrate; applying an image toner on the substrate; heating the image toner which causes the image toner to fix to the substrate and causes low surface energy component in the image toner to migrate to a surface of a formed image; applying a non-image toner on the surface of the formed image and the substrate; fusing the non-image toner which fuses the non-image toner to the surface of the formed image and the substrate, which causes the fused non-image toner to fuse to a level that permits scratch-off of a scratch-off portion of the fused non-image toner.

### CROSS REFERENCE TO RELATED APPLICATIONS

Reference is made to commonly-assigned, co-pending U.S. patent application Ser. No. ______ (Kodak Docket K000642US01) filed concurrently herewith, entitled “METHOD FOR CREATING A SCRATCH-FF DOCUMENT USING SINTERING” by Dinesh Tyagi, et al., the disclosure of which is incorporated herein.

### FIELD OF THE INVENTION

The present invention generally relates to scratch-off documents having an image toner covered by non-image toner and more particularly to including low surface energy components in the image toner to permit easy removal of the fused or sintered non-image toner.

### BACKGROUND OF THE INVENTION

Currently, scratch-off documents are used for a variety of applications. One of the most commonly used applications is the use of scratch-off documents for creating lottery tickets. In this application, a person purchases a lottery ticket and uses a hard object to scratch off the portion of the ticket covering hidden information such as a particular number. The use of scratch-off documents has vastly increased over the past years and several prior art documents address creating scratch-off documents.

In this regard, U.S. Patent Publication 2007/0281224 is directed to a scratch-off document in which a first layer of toner forms an image and an optional barrier layer, typically clear, is deposited hereon. The first layer is well adhered to the substrate and the barrier layer is well adhered to the first layer. A second removable layer of toner is adhered to the first layer and can be removed when scratched using a hard object, leaving the first layer intact on the substrate. The application of the barrier layer is carried out offline and the document is reprinted with the scratch-off layer. The barrier layer is a UV cross-linkable composition and thus separates the first and second toner layer. Although, the same toner composition and toner size particles can be used for the first and second toner layers, the extra step of applying a barrier layer adds cost and complexity to the process of making a scratch off document.

U.S. Patent Publication 2008/0131176 is directed to an apparatus and method for producing a scratch-off document in which front side information containing the information to be hidden prior to scratch-off is first fused or otherwise well adhered to the base material prior to the printing of a removable scratch-off layer. The indicia is printed and then a pile height leveling ink is added so that the portion of the indicia to be covered is not visible through the removable layer. In an embodiment, oil is externally applied to the surface of the image. The extra amount of toner and additional step of applying oil to the first information layer makes this approach economically unattractive.

U.S. Patent Publication 2009/0263583 is directed to a scratch-off document in which the information layer includes both an indicia and a noise component of varying height. A scratch off layer is deposited over the noise component. This variable height functions to obscure the indicia so that it is not easily seen until scratched off. In order to overcome the pile height differences, which could become visible even though there is a removable layer printed with typical low fusing toners, a noise component is also added to the indicia prior to applying the removable layer. Again, there is extra cost associated with the use of additional toner. Further, the low fusing toner compositions are not well suited for providing long developer life because of carrier scumming.

U.S. Pat. No. 8,342,576 is directed to a scratch-off document having a first toner layer containing hidden information (i.e., the image that will eventually be revealed to the user after scratch off). The first toner layer is then covered by a printed, removable, waxy scratch-off layer having a distraction pattern. The scratch off layer by the ink-jet printing process includes ink composition is that of a phase change ink, and the solid mass is heated above the melting temperature to produce a low viscosity ink which can be then jetted. Because the phase change inks comprise a low molecular weight crystalline resin, they do not have sufficient mechanical strength to withstand typical mechanical abrasion caused during normal handling.

Although each method is satisfactory, cost efficiency improvements are always needed, as is the need for simple, but efficient scratch-off documents.

### SUMMARY OF THE INVENTION

A method of creating a scratch-off document, the method includes the steps of providing a substrate; applying an image toner on the substrate; heating the image toner which causes the image toner to fix to the substrate and causes low surface energy component in the image toner to migrate to a surface of a formed image; applying a non-image toner on the surface of the formed image and the substrate; fusing the non-image toner which fuses the non-image toner to the surface of the formed image and the substrate, which causes the fused non-image toner to fuse to a level that permits scratch-off of a scratch-off portion of the fused non-image toner.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, and wherein:

FIG. 1 is a block diagram of an electro-photographic reproduction apparatus suitable for use in the practice of the present invention;

FIG. 2 is a side view in cross section illustrating a substrate having image toner deposited thereon;

FIG. 3 is a side view of FIG. 2 after the image toner is fixed to the substrate;

FIG. 4 is a side view of FIG. 3 illustrating non-image toner deposited onto the image toner;

FIG. 5 is a side view of FIG. 4 after the non-image toner is fused;

FIG. 6 is a side view of FIG. 5 after the non-image toner is removed by a scratch-off tool revealing hidden information;

FIG. 7 is a top view of FIG. 6, along line 6-6, with the scratch off tool removed from view for illustrating the hidden information, the letter “K” in this example;

FIG. 8 is an alternative embodiment of FIG. 1 of an electro-photographic reproduction apparatus suitable for use in the practice of the present invention;

FIG. 9 is a side view of an alternative embodiment of FIG. 5 having a sintered non-image toner deposited on the formed image; and

FIG. 10 is side view of the alternative embodiment after the non-image toner is removed by a scratch-off tool revealing hidden information.

### DETAILED DESCRIPTION OF THE INVENTION

Before turning to the description of the present invention, it is important to note terms as used herein. In this regard, “sintering” means to form a continuous or substantially continuous mass without melting or without substantially melting. In sintering, the toner particles coalesce into a continuous mass through the application of pressure resulting in cold flow and cohesion of the particles. When a toner image is “fixed” to a substrate, sufficient heat is provided to cause a melt flow of the toner melt to penetrate into the substrate structure or to simply provide mechanical interlocking with the substrate. Thus the final image is well adhered to the substrate and cannot be removed easily. The resulting, well adhered images do not lend themselves to provide a scratch off document. However, by using the “sintering” process, the toner mass can be made to flow at ambient or very low temperatures. This can be achieved by making the toner particles undergo cold flow. Cold Flow can be described as the distortion, deformation, or dimensional change which takes place in materials under load at temperatures within the working range. In other words, cold flow is described as flow of thermoplastics materials that occurs at less than the optimum melt temperatures. Cold flow may also be described in terms of plastics under severe friction conditions. Therefore, cold flow is not due to heat softening or a melt process in which the materials have to undergo a transition. It is sometimes described as creep or compression set of the polymer that occurs at ambient temperature and is related to the viscoelastic flow of polymers under applied pressure. It is understood by those skilled in the art that partial melting may occur as a result of imprecision of the devices used or melted intentionally to a partial degree that still achieves the result of permitting scratch-off.

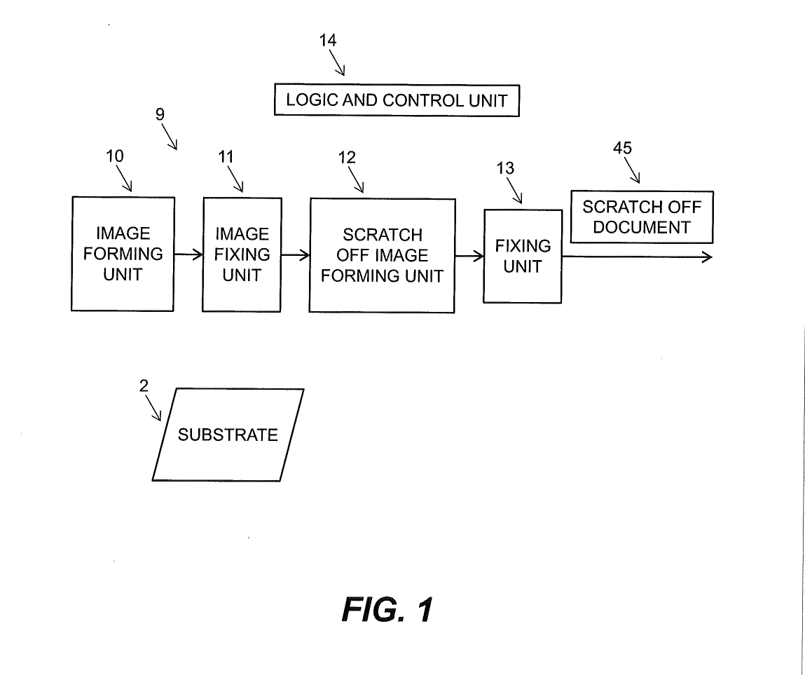

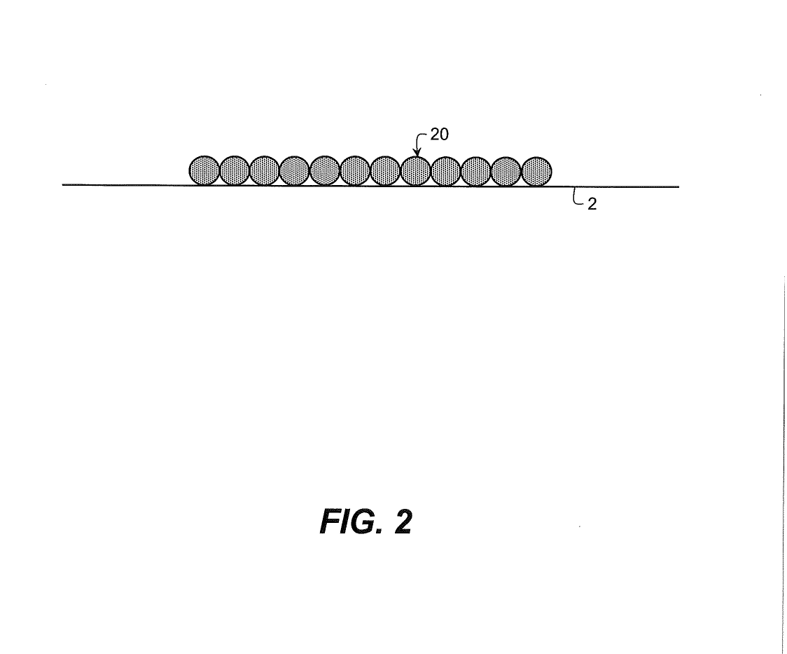

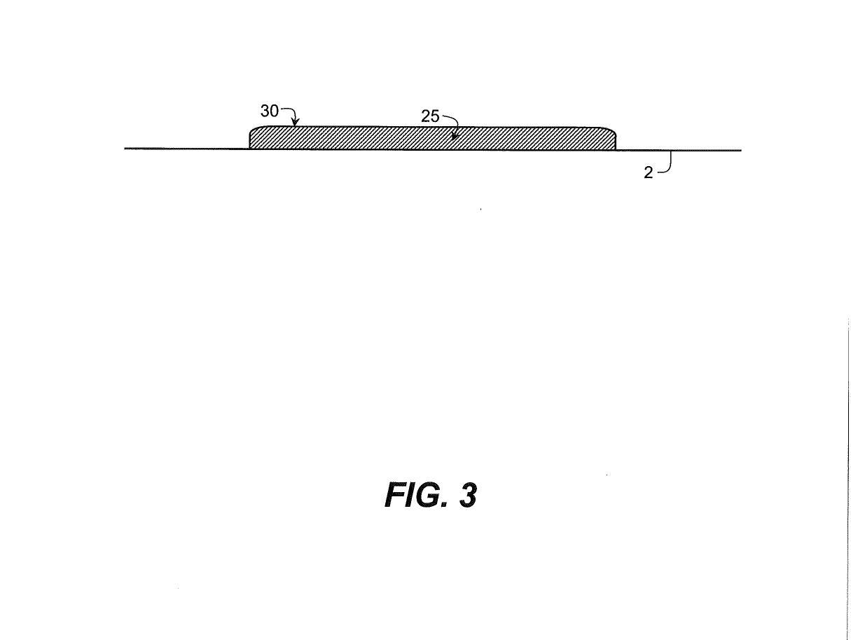

Referring now to FIG. 1, there is shown a block diagram of a scratch-off document apparatus 9. The scratch-off document apparatus 9 includes an image forming unit 10 into which a substrate 2 is input. The substrate 2 is preferably, but not limited to, paper or any suitable printing media receptive to toner printing. The image forming unit 10 deposits image toner 20 (as shown in FIG. 2) onto the substrate 2, as is well known in the art. It is noted that the image toner 20 is patterned in a predetermined shape on the substrate 2. This predetermined shape is representative of, but not limited to, symbols, numbers, letters and other symbols used in writing, art and the like. The substrate 2 with the deposited image toner 20 is passed to an image fixing unit 11. The image fixing unit 11 heats the image toner 20 forming a formed image 25 which is fixed to the substrate 2, as shown in FIG. 3. This heating causes the low surface energy components to migrate to a surface 30 of the formed image 25 (illustrated by the heavy line in FIG. 3). The formed image 25 is fixed using nip forming heated rollers, radiant fusing, flash fusing, microwave fusing or solvent fusing, all of which are well known in the art. It is noted that the image toner 20 includes one or more of the low surface energy additives selected from the group comprising, aliphatic hydrocarbons, olefinic hydrocarbons, silicones and fluorocarbons. The low surface energy additives could be present in the form of an acid, amide, alcohol or a salt. The amount of low surface energy additives is between 1 and 10% by weight of the toner.

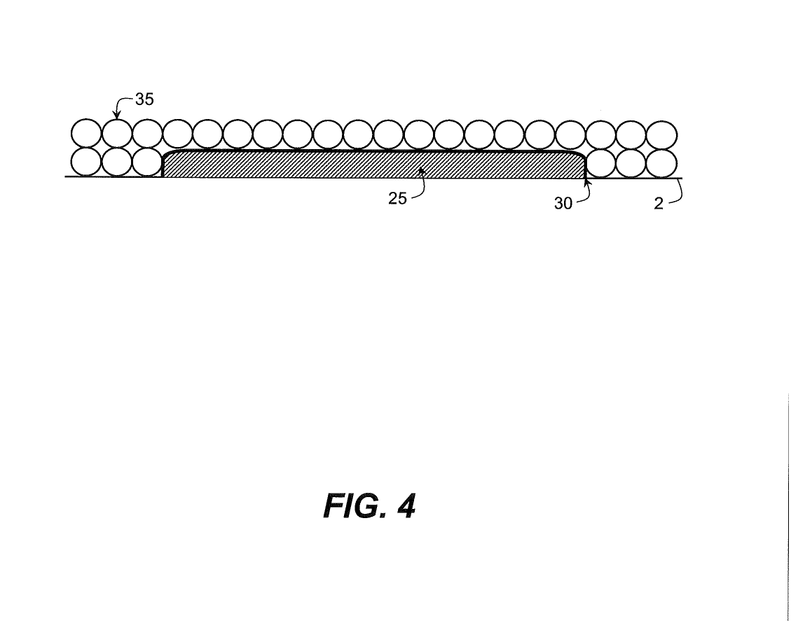

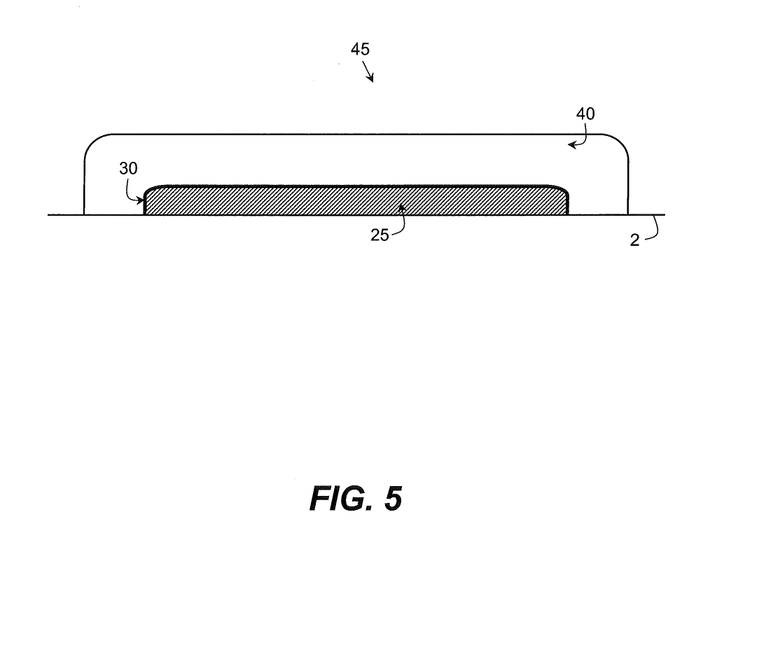

Referring back to FIG. 1, the substrate 2 with the formed image 25 (FIG. 3) is then passed to a scratch-off image forming unit 12, which deposits non-image toner 35 (FIG. 4), preferably opaque, onto the surface 30 of the formed image 25 and portions of the substrate 2 that extend beyond the formed image 25 and that are not covered by the formed image 25, as illustrated in FIG. 4. The substrate 2 with the non-image toner 35 is then passed to a fixing unit 13, (FIG. 1) which fuses the non-image toner 35 to the substrate 2 forming a fused non-image toner 40, as shown in FIG. 5. The result is a scratch-off document 45 in which portions of the fused non-image toner 40 can be scratched-off, as described below. A logic and control unit 14 (FIG. 1) controls the scratch-off document apparatus 9 as is well known in the art.

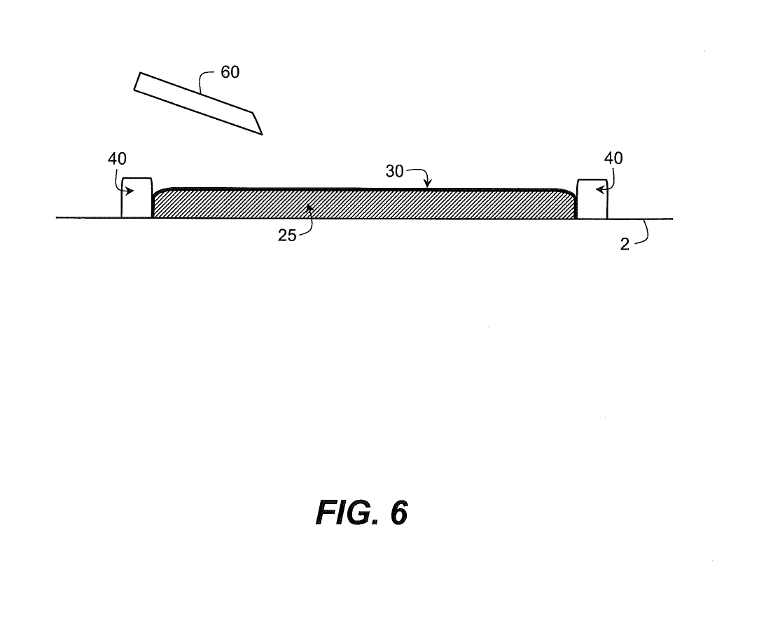

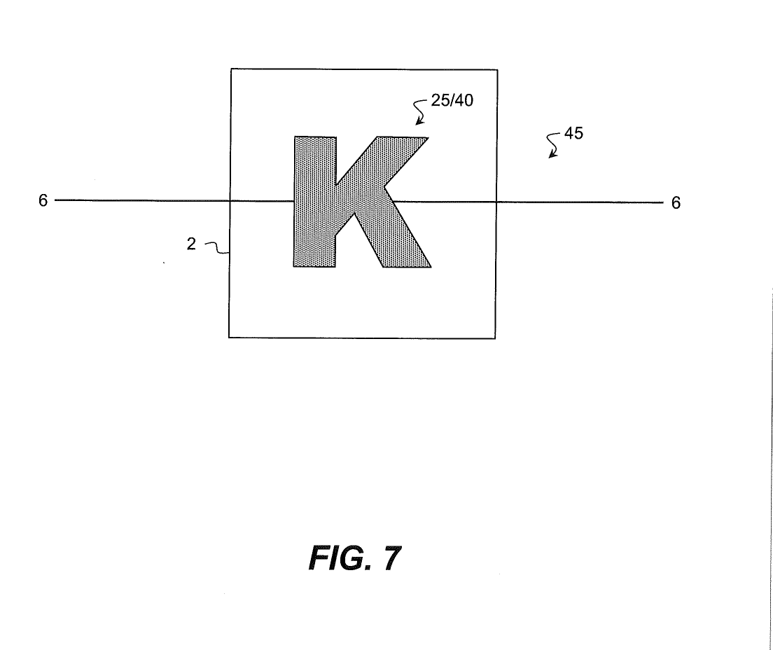

Referring to FIG. 6, there is shown a scratch-off tool 60, such as a hard rigid object, fingernail or any object suitable for scratching off (rubbing and the like) the scratch-off portion of the fused non-image toner 40. When a scratch-off portion of the fused non-image toner 40 is removed, the hidden information formed by the formed image 25 is revealed. A “scratch-off portion of the fused image toner” is defined as the fused non-image toner 40 covering the surface 30 of the formed image 25 that extends opposite or substantially opposite the substrate 2. This is because the portion of the fused non-image toner 40 abutting and resting on the substrate 2 is sufficiently adhered to the substrate 2 so that it remains intact during scratch-off. The low surface energy component at the surface 30 of the formed image 25 causes the fused non-image toner 40 to be adhered to a level that permits scratch-off of the fused non-image toner 40 covering the surface 30. As is well understood by those skilled in the art, the fused non-image toner 40 covering side portions of the formed image 25 are not removed as this portion of the fused non-image toner 40 is also in contact with the substrate 2. Referring to FIG. 7, there is shown the letter “K” formed by the formed image 25, as an example.

The fused non-image toner 40 preferably has properties that permit it to scratch-off optimally. The non-image toner 35 is preferably greater than 0.7 mg/cm2 and has a mean size of between 15 to 50 microns.

The image toner 20 also has properties which are optimal for scratch-off documents. In this regard, the image toner 20 is preferably made of visible pigments that are monochrome or made of at least two toners with different colorants. The image toner 20 preferably has a mean size between 4 to 10 microns and the combined mass of the image toner 20 is less than 0.7 mg/cm².

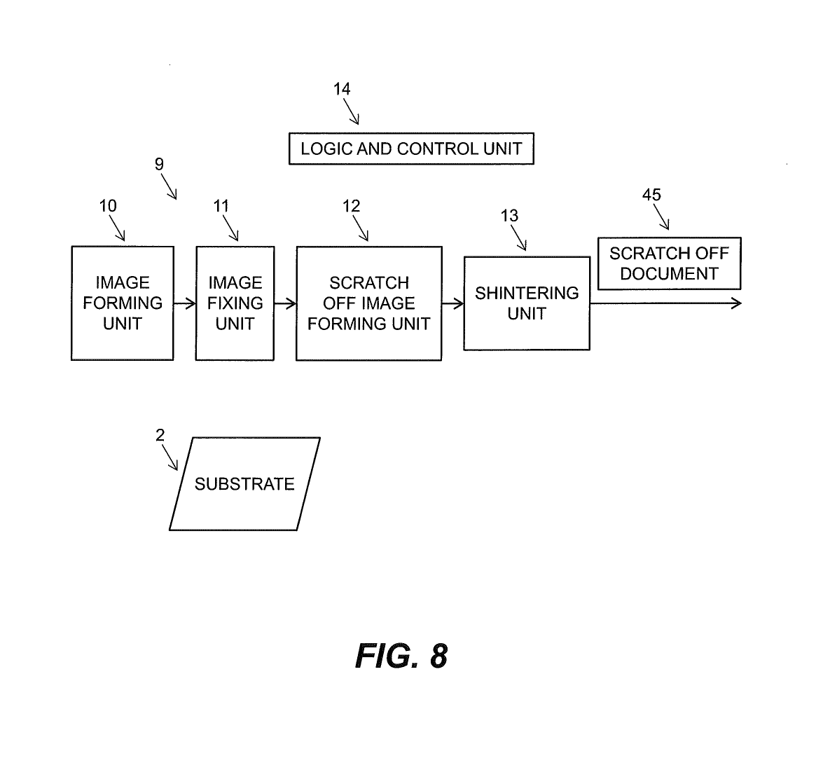

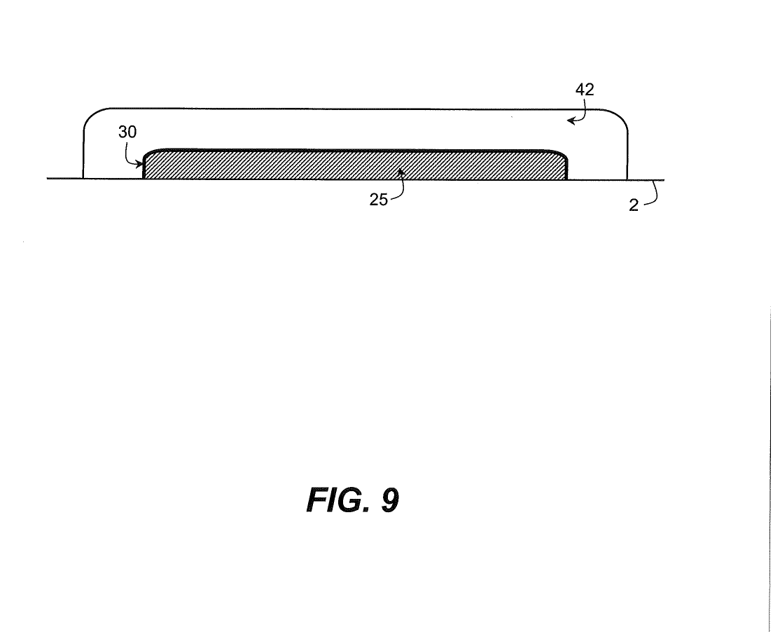

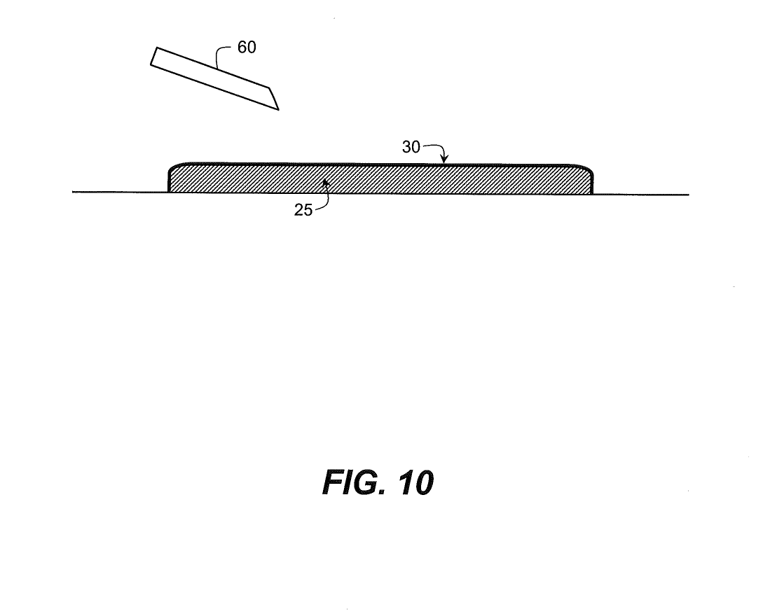

Referring to FIG. 8, there is shown a block diagram of an alternative embodiment of the scratch-off document apparatus 9. The image forming unit 10, the image fixing unit 11, and the scratch off image forming unit 12 are the same as in FIG. 1. The substrate 2 is similarly deposited with image toner 20 and heated to create the formed image 25 in which the low energy components migrate to the surface 30, and non-image toner 35 then is deposited on the formed image 25. Unlike the previous embodiment, the non-image toner 35 is sintered by the sintering unit 15 forming a sintered, non-image toner 42 as shown in FIG. 9. Referring to FIG. 10, when the scratch off tool 60 removes the sintered, non-image toner 42, the formed image 25 is revealed. It is important to note that all of the sintered non-image toner 42 is removed since sintering adheres the sintered non-image toner 42 at a level which permits scratch off both from the surface 30 and the substrate 2.

It is noted that the image toner 20 and non-image toner 35 of the alternative embodiments have the same composition and characteristics as the preferred embodiment.

The low surface energy additives that can be used in image toner can be selected from, but not limited to, the group consisting aliphatic or olefinic hydrocarbons, fluorocarbons and polydimethylsiloxanes.

The image toner additive used in the present invention have a surface energy of 10 to 35 mN/m at 25° C., and more preferably, from 20 to 35 mN/m at 25° C. Such toners can be made by adding the low surface energy additives to toner compositions. Toners containing low surface energy additives are known. For example, U.S. Pat. No. 4,513,074 discloses the use of waxes such as low molecular weight polyalkylene waxes in toner compositions; U.S. Pat. No. 3,655,374 discloses toner compositions containing metal salts of fatty acids; and U.K. Patent 1,442,835 discloses toner compositions containing a combination of fatty acids with polyalkylene compounds, such as polyethylene and polypropylene, to prevent toner offset. However, these disclosures do not teach or suggest taking advantage of the low surface energy additives which, under proper fusing conditions will migrate to the surface and reapplying a non-image toner over the image tone and refusing the entire image.

In the present invention, when release additives are used in the toner composition, the polymer binders can include vinyl polymers, such as homopolymers and copolymers of styrene and condensation polymers such as polyesters and copolyesters. Particularly useful binder polymers are styrene polymers of from 40 to 100 percent by weight of styrene or styrene homologs and from 0 to 45 percent by weight of one or more lower alkyl acrylates or methacrylates. Fusible styrene-acrylic copolymers which are covalently lightly crosslinked with a divinyl compound such as divinylbenzene, as disclosed in U.S. Reissue Pat. No. 31,072, are particularly useful. Also especially useful are polyesters of aromatic dicarboxylic acids with one or more aliphatic diols, such as polyesters of isophthalic or terephthalic acid with diols such as ethylene glycol, cyclohexane dimethanol and bisphenols.

Another useful binder polymer composition comprises a copolymer of a substituted vinyl aromatic monomer; a second monomer selected from the group consisting of conjugated diene monomers or acrylate monomers selected from the group consisting of alkyl acrylate monomers and alkyl methacrylate monomers; and a third monomer which is a crosslinking agent.

The toner binder polymers can be amorphous or semicrystalline polymers. The amorphous toner binder compositions useful in present invention have a Tg in the range of about 45 to 120° C., and often about 50 to 70° C. The useful semi-crystalline polymers have a Tm in the range of about 50 to 150° C. and more preferably between 60 and 125° C. Such polymers can be heat-fixed to film supports as well as to more conventional substrates, such as paper, without difficulty. The thermal characteristics, such as Tg and Tm, can be determined by any conventional method, e.g., differential scanning calorimetry (DSC).

Preferred toner additives which can provide the desired low surface energy with binders such as those described above include C8-C24 aliphatic amides, C8-C24 aliphatic acids, including metal salts of such aliphatic amides and aliphatic acids, diblock or triblock copolymer of styrene and ethylene-propylene blocks, C8-C30 aliphatic succinic anhydrides, hydroxy terminated polyethylene waxes having a number average molecular weight of 300 to 3,000, polypropylene waxes having a number average molecular weight of 5,000 to 15,000 and an aliphatic semicrystalline polyester having a C2-C12 acid component and a C2-C20 diol component. Suitable aliphatic amides and aliphatic acids are described, for example, in Practical Organic Chemistry, Arthur I. Vogel, 3rd Ed. John Wiley and Sons, Inc. N.Y. (1962); and Thermoplastic Additives: Theory and Practice John T. Lutz Jr. Ed., Marcel Dekker, Inc, N.Y. (1989). Particularly useful aliphatic amide or aliphatic acids have from 8 to about 24 carbon atoms in the aliphatic chain. Examples of useful aliphatic amides and aliphatic acids include oleamide, eucamide, stearamide, behenamide, ethylene bis(oleamide), ethylene bis(stearamide), ethylene bis(behenamide) and long chain acids including stearic, lauric, montanic, behenic, oleic and tall oil acids. Particularly preferred aliphatic amides and acids include stearamide, erucamide, ethylene bis-stearamide and stearic acid. The aliphatic amide or aliphatic acid is present in an amount from about 0.5 to 30 percent by weight, preferably from about 1 to 10 percent by weight. Mixtures of aliphatic amides and aliphatic acids can also be used. One useful stearamide is commercially available from Witco Corporation as Kemamide S™. A useful stearic acid is available from Witco Corporation as Hysterene 9718™. Examples of other additives include polyolefin waxes such as Viscol® 660P and 550P polypropylene waxes available from Sanyo Chemicals, low molecular weight polyethylene waxes such as Polywaxes® and Unilins® waxes available from Petrolite Corporation, poly(decamethylene sebacate), metal stearates such as zinc stearate, Kraton® diblock or triblock copolymers available from Shell Development Company, and octadecyl succinic anhydrides. Typically, these additives are incorporated into the toner formulations during melt compounding either directly or via a dispersion, or to the limited coalescence process of making a toner via a dispersion, as disclosed in U.S. Pat. No. 4,883,060, which is incorporated herein by reference. Toner of this invention can be also be prepared by using other chemical methods of making toners such as suspension polymerization, emulsion aggregation and the like. Numerous dyestuffs or pigments can be employed as colorants in the toner particles. Suitable toners can be prepared without a colorant where it is desired to form toner images of low optical densities. Colorants can be selected from virtually any of the compounds mentioned in the Colour Index Volumes 1 and 2, Second Edition. For multicolor imaging, suitable colorants include those typically employed in primary subtractive cyan, magenta and yellow colored toners. Such dyes and pigments are disclosed, for example, in U.S. Reissue Pat. No. 31,072, which is incorporated herein by reference. A particularly useful colorant for toners to be used in black and white electrostatographic copying machines and printers is carbon black. The amount of colorant added may vary over a wide range, for example, from about 1 to 20 percent of the weight of binder polymer used in the toner particles. Good results are obtained when the amount is from about 1 to 10 percent. Mixtures of colorants can also be used.

Another component of the toner composition is a charge control agent. The term “charge control” refers to a propensity of a toner addendum to modify the triboelectric charging properties of the resulting toner. Charge control agents for either negative or positive charging toners are available. Suitable charge control agents are disclosed, for example, in U.S. Pat. Nos. 3,893,935; 4,079,014, and 4,323,634, all of which are incorporated herein by reference. Charge control agents are generally employed in small quantities such as, from about 0.1 to about 5 weight percent based upon the weight of the toner. Mixtures of charge control agents can also be used.

The toner can also contain other additives of the types used in previous toners, including magnetic pigments, leveling agents, surfactants, stabilizers, and other addenda well known in the art. The total quantity of such additives can vary but, preferably, are not more than about 10 weight percent of such additives on a total toner powder composition weight basis. In the case of MICR (magnetic ink character recognition) toners, however, the weight percent of iron oxide can be as high as 40% by weight.

The polymer binders can be melt blended with the addenda in a two roll mill or extruder. A preformed mechanical blend of particulate polymer particles, colorants and other toner additives can be prepared and then roll milled or extruded at a temperature sufficient to achieve a uniformly blended composition. For a polymer having a Tg in the range of 50° C. to 120° C., or a Tm in the range of 65° C. to 200° C., a melt blending temperature in the range of 90° C. to 240.° C. is suitable using a roll mill or extruder. Melt blending times, that is, the exposure period for melt blending at elevated temperature, are in the range of 1 to 60 minutes.

The melt product is cooled and then pulverized to a volume average particle size of from 1 to 100 micrometers to yield the toner particles. It is preferred to grind the melt product before pulverizing it. The solid composition can be crushed and then ground using, for example, a fluid energy or jet mill, such as described in U.S. Pat. No. 4,089,472 and can then be classified in one or more steps.

The toner compositions can also be made with a process that is a modification of the evaporative limited coalescence process described in U.S. Pat. No. 4,883,060, cited above. This method of making toner particles is especially useful when the polymer binder has such toughness that it cannot be pulverized by conventional procedures, but can be dissolved in a solvent. To prepare toners for use in the present invention the release additive is either dissolved or milled in the presence of a solution of the binder polymer so as to form a solution or dispersion of fine particles of the release additive in the binder polymer solution. This concentrate is then added to the remainder of the binder polymer solution and the process according to U.S. Pat. No. 4,883,060 is carried out. This produces binder polymer particles in which the release additive is uniformly distributed.

The toner can also be surface treated with small inorganic particles to impart powder flow or cleaning or improved transfer. The transfer assisting particles typically are smaller than 0.4 μm, preferably between about 0.01 and 0.2 μm, and most preferably about 0.05 to 0.1 μm. Preferred addenda are inorganic particles, but organic particles can also be used.

Commonly, the toner is applied by means of a single component or a dual component development system. The dual component development method includes a carrier to charge and bring the toner composition in the development zone. Examples of carriers are disclosed, for example, in U.S. Reissue Pat. No. 31,072, cited above. Especially useful in magnetic brush development procedures are iron particles such as porous iron particles having oxidized surfaces, steel particles, and other “hard” and “soft” ferromagnetic materials such as gamma ferric oxides or ferrites of barium, strontium, lead, magnesium, or aluminum. Such carriers are disclosed, for example, in U.S. Pat. No. 5,248,339 and in the references cited therein, all of which are incorporated herein by reference.

Image toner particles useful in the present invention have an average diameter in the range of about 1 to 12 μm, a value of about 4 to 10 μm being particularly useful in many electrophotographic systems. The non-image toner particles useful in the present invention have an average diameter in the range of about 15 to 100 μm, a value of about 15 to 50 μm being particularly useful for providing the tactile overcoat to be scratched off. The term “particle size” used herein means the median volume weighted diameter as measured by conventional diameter measuring devices, such as a Coulter Multisizer, sold by Coulter, Inc. of Hialeah, Fla. Median volume weighted diameter is the diameter of an equivalent weight spherical particle which represents the median for a sample.

Surface energy of toner particles of the present invention were measured as follows. First a disk of the toner powder was produced by compression molding the toner powder in a mold at 10,000 psi at room temperature. Various surface imperfections and modulations present on the sample surface were removed by polishing the surface of the disk using a Buehler Ecomet 3 polisher available with a 600 grit grinding surface and a 0.05 micron polishing surface. The top surface of the slab sample was then exposed to 150° C. for two minutes. The surface energy was then measured by contact angle techniques, with diiodomethane and water as the liquids.

The present invention has been described in detail with particular reference to certain preferred embodiments thereof, but it will be understood that variations and modifications can be effected within the spirit and scope of the invention.

### PARTS LIST

2 substrate
9 scratch-off document apparatus
10 image forming unit
11 image fixing unit
12 scratch-off image forming unit
13 fixing unit
14 logic and control unit
15 sintering unit
20 image toner
25 formed image
30 surface
35 non-image toner
40 fused non-image toner
42 sintered non-image toner
45 scratch-off document
60 scratch-off tool

1. A method of creating a scratch-off document, the method comprising:
providing a substrate;
applying an image toner on the substrate;
heating the image toner which causes the image toner to fix to the substrate and causes low surface energy component in the image toner to migrate to a surface of a formed image;
applying a non-image toner on the surface of the formed image and the substrate;
fusing the non-image toner which fixes the non-image toner to the surface of the formed image and the substrate, which causes the fused non-image toner to fuse to a level that permits scratch-off of a scratch-off portion of the fused non-image toner.

2. The method according to claim 1, wherein the mass of the non-image toner is greater than 0.7 mg/cm2.

3. The method according to claim 1, wherein the image toner is fixed using nip forming heated rollers, radiant fusing, flash fusing, microwave fusing or solvent fusing.

4. The method according to claim 1 wherein the mean size of the image toner used 4 to 10 microns.

5. The method according to claim 1 wherein the mean size of the non image toner used 15 to 100 microns.

6. The method according to claim 1, wherein the combined mass of the image toners is less than 0.7 mg/cm2.

7. The method according to claim 4 wherein the image toners comprise a visible pigments to form an image

8. The method according to claim 5 wherein the image is monochrome or a composite image produced by combining at least two toners with different colorants.

9. The method according to claim 1, wherein the surface energy of the low surface energy additives is between 10 and 35 mN/m at 25° C. or more preferably between 18 and 35 mN/m at 25° C.

10. The method according to claim 1, wherein the image toner contains one or more of the low surface energy additives selected from the group comprising, aliphatic hydrocarbons, olefinic hydrocarbons, silicones and fluorocarbons.

11. The method according to claim 9, wherein the aliphatic or olefinic hydrocarbons or silicones could be present in the form of an acid, amide, alcohol or a salt.

12. The method according to claim 10, wherein the amount of low surface energy additives is between 1 and 10% by weight of the toner.

13. The method according to claim 1, wherein the non-image toner is opaque.

14. The method according to claim 1, wherein the non-image toner is either sintered or fixed using nip forming heated rollers, radiant fusing, flash fusing, microwave fusing, solvent fusing.

15. A method of creating a scratch-off document, the method comprising the steps of:
providing a substrate;
applying an image toner on the substrate;
heating the image toner which causes the image toner to fix to the substrate and causes low surface energy component in the image toner to migrate to a surface of a formed image;
applying a non-image toner on the surface of the formed image and the substrate;
sintering the non-image toner which adheres the non-image toner to the substrate and to the surface of the formed image which causes the sintered non-image toner to adhere at a level that permits scratch-off.

16. The method according to claim 15, wherein the mass of the non-image toner is greater than 0.7 mg/cm2.

17. The method according to claim 15, wherein the image toner is fixed using nip forming heated rollers, radiant fusing, flash fusing, microwave fusing or solvent fusing.

18. The method according to claim 15, wherein the mean size of the image toner used 4 to 10 microns.

19. The method according to claim 15, wherein the mean size of the non image toner used 15 to 100 microns.

20. The method according to claim 15, wherein the combined mass of the image toners is less than 0.7 mg/cm2.

21. The method according to claim 20 wherein the image toners comprise a visible pigments to form an image.

22. The method according to claim 20 wherein the image is monochrome or a composite image produced by combining at least two toners with different colorants.

23. The method according to claim 20, wherein, the surface energy of the low surface energy additives is between 10 and 35 mN/m at 25° C. or more preferably between 18 and 35 mN/m at 25° C.

24. The method according to claim 15, wherein the image toner contains one or more of the low surface energy additives selected from the group comprising, aliphatic hydrocarbons, olefinic hydrocarbons, silicones and fluorocarbons.

25. The method according to claim 24, wherein the aliphatic or olefinic hydrocarbons or silicones could be present in the form of an acid, amide, alcohol or a salt.

26. The method according to claim 24, wherein the amount of low surface energy additives is between 1 and 10% by weight of the toner.

27. The method according to claim 15, wherein the non-image toner is opaque.

28. The method according to claim 15, wherein the non-image toner is either sintered or fixed using nip forming heated rollers, radiant fusing, flash fusing, microwave fusing, solvent fusing.
